(19) United States
(12) Patent Application Publication
(10) Pub. No.: US 2014/0115050 A1
(43) Pub. Date: Apr. 24, 2014

(54) Method And System For Transcoding

(71) Applicant: TENCENT TECHNOLOGY (SHENZHEN) COMPANY LIMITED, Shenzhen City (CN)

(72) Inventors: Gang LIU, Shenzhen City (CN); Yunsheng WU, Shenzhen City (CN); Yan HUANG, Shenzhen City (CN)

(73) Assignee: TENCENT TECHNOLOGY (SHENZHEN) COMPANY LIMITED, Shenzhen City (CN)

(21) Appl. No.: 14/145,210

(22) Filed: Dec. 31, 2013

Related U.S. Application Data
(63) Continuation of application No. PCT/CN2012/077599, filed on Jun. 27, 2012.

(30) Foreign Application Priority Data
Jul. 11, 2011 (CN) 201110192492.5

(51) Int. Cl. H04L 29/08

(52) U.S. Cl. CPC H04L 67/10
USPC 709/203

(57) ABSTRACT

A transcoding method, which includes a transcoding request from a client, is received by a server side. When determining that a destination file corresponding to the transcoding request exists in the server side, destination file information may be returned to the client. When determining that the destination file corresponding to the transcoding request does not exist in the server side, after executing transcoding operations by the server side, the destination file information obtained after executing the transcoding operations may be returned to the client.

### CROSS-REFERENCE TO RELATED APPLICATIONS

This application is a continuation of International Patent Application No. PCT/CN2012/077599 filed on Jun. 27, 2012. This application claims the benefit and priority Chinese Patent Application No. 201110192492.5, filed Jul. 11, 2011. The entire disclosures of each of the above applications are incorporated herein by reference.

### FIELD

The present disclosure relates to data processing technologies and to a method and system for transcoding.

### BACKGROUND

This section provides background information related to the present disclosure which is not necessarily prior art.

At present, format conversion system mainly includes video converter, audio converter, picture format converter, document format converter, and so on. The video converter may convert a video signal from one format into another format, such that multi-standard digital video conversion requirements of wider areas may be met. Accompanying continuous evolvement of the Internet and mobile network, there are more and more media transmission platforms. Correspondingly, there are more and more media formats supported by various transmission platforms. From mobile phone, Internet Protocol Television (IPTV), to High-Definition (HD) digital broadcasting, requirements regarding content format put forward by different platforms are completely different. The foregoing requirements may include encoding format/specification, resolution, frame rate, and so on. Thus, conversions of content encoding formats become indispensable.

Take video conversion as an example, at present, there are three main transcoding requirements. Convert among different video formats. For example, convert from Moving Pictures Experts Group-2 (MPEG-2) or MPEG-4 to H.264. Change bit rate to meet different network bandwidths or device playing speeds. Convert definitions, e.g., convert HD video into Standard Definition (SD) video or video with a lower resolution, or reverse process. For example, in order to edit and upload information to a website, transmit a video from a camera to a Personal Computer (PC) application, it is necessary to convert among different video formats. Specifically speaking, during the process of transmitting the video from the camera to the PC, it is necessary to convert the video from an Audio Video Interleaved (AVI) format into MPEG-2 used for editing, or into MPEG-4 used for storing. During the process of transmitting the video from the PC to the website, it is necessary to convert the video from MPEG-2, or MPEG-4 into H.263, H.264, Flash and so on. When needing to view website files via the PC, it is necessary to execute format conversion once again, such that the video may be played by using RealPlayer or Windows Media Player.

In the existing technical solutions, in order to complete foregoing transcoding requirements, an ordinary user generally needs to locally install dedicated transcoding software (different software supports different formats). Subsequently, an original file to be transcoded may be imported. A destination format needs to be output may be selected. Related transcoding parameters may be set, such as an output file name, code rate, whether to divide a movie, and so on. Then, the transcoding process may be initiated, waiting for the end of the transcoding. In addition, when needing to play video on a mobile device, if there is no suitable video format used for playing directly via the mobile device, it generally needs to complete the transcoding on the PC, and then to be synchronized to the mobile device to be played. In the prior art, a dedicated hardware transcoding device may also be employed. By using a dedicated transcoding processor, tasks of a core processor may be reduced, and a higher transcoding efficiency may be implemented.

Accompanying with rapid developments of multimedia and computer technologies, great success has been achieved by video playing and application on PCs. With the 3G era, popularity of mobile phone video increases day by day. Requirements of mobile video are increasing explosively. Desires of people to access multimedia resources at any time and any place are increasing day by day. When playing video on a mobile device, the problem of video format conversion is generally involved. However, since current transcoding is mainly executed by clients, the following deficiencies may exist.

1) Video transcoding is a process with higher calculation loads. It is necessary to perform a full decoding, a video filter/an image processing on an input video stream. It is necessary to perform a full encoding on an output format. Thus, multimedia transcoding (especially the video transcoding) is a very time-consuming process with calculation resources consumed, which is especially applicable for HD video. Even if tasks of core processor may be reduced by employing a dedicated transcoding processor, since data amount needs to be processed by HD transcoding is much larger than that needs to be processed by SD format, a lot of system resources of clients may still be consumed.

2) Initiation and execution of transcoding operation instructions are carried out by clients, which may occupy a lot of local Central Processing Unit (CPU) time of a user. Meanwhile, the user needs to wait for a time period to obtain transcoded multimedia data, and user experience is poor. For the same file, under the circumstances that one user needs to transcode and transcoding has been completed locally, when another user needs the same file, another user also needs to transcode locally. In other words, transcoded files cannot be shared.

3) Since mobile device of each type has a maximum supported video resolution, most of mobile devices don't support a video with a video resolution larger than screen physical resolution of the mobile devices. The mobile device of each type may also have a maximum supported code rate, which is generally less than 1M bps. Newer mobile device may have a maximum supported frame rate of 30 fps. Thus, when transcoding by a client, a user needs to understand a lot of background knowledge about encoding, such as resolution, code rate, frame rate, so as to correctly complete transcoding operations.

### SUMMARY

This section provides a general summary of the disclosure, and is not a comprehensive disclosure of its full scope or all of its features.

In view of above, the main objectives of the present disclosure are to provide a method and system for transcoding, so as to save client resources.

To achieve the foregoing objectives, technical solutions of the present disclosure may be implemented as follows.

A transcoding method, including:

receiving, by a server side, a transcoding request from a client;

determining, by the server side, whether a destination file corresponding to the transcoding request already exists in the server side;

when determining that the destination file corresponding to the transcoding request already exists in the server side, returning, by the server side, destination file information to the client; and

when determining that the destination file corresponding to the transcoding request does not exist in the server side, executing, by the server side, transcoding operations, and returning the destination file information obtained after executing the transcoding operations to the client.

A transcoding system, including a server side and a client, in which

the server side is to determine whether a destination file corresponding to a transcoding request already exists in the server side, after receiving the transcoding request from the client;

when determining that the destination file corresponding to the transcoding request already exists in the server side, the server side is further to return destination file information to the client;

when determining that the destination file corresponding to the transcoding request does not exist in the server side, the server side is further to execute transcoding operations, and return the destination file information obtained after executing the transcoding operations to the client; and

the client is to transmit the transcoding request to the server side, and obtain the destination file from the server side, after receiving the destination file information from the server side.

In accordance with the method and system for transcoding provided by various embodiments, after receiving a transcoding request from a client, when determining that a destination file corresponding to the transcoding request already exists in a server side, the server side may return destination file information to the client. When determining that the destination file corresponding to the transcoding request does not exist in the server side, after executing transcoding operations, the server side may return the destination file information to the client. Subsequently, the client may obtain the destination file from the server side. Since in various embodiments the server side may execute the transcoding operations, client resources may be saved. After the client initiates the transcoding request, when the server side stores a file requested by the client, the file may be immediately provided for the client, such that waiting time of a user may be reduced, and user experience may be improved. Furthermore, the user only needs to submit a transcoding task to the server side, and to extract a file from a specified location. Thus, it is not necessary for the user to understand a lot of encoding background knowledge, and is convenient for executing operations. In accordance with various embodiments, by employing a transcoding mode provided by the server side, files of various formats may be shared by terminal devices of different types.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a flowchart illustrating a transcoding method, in accordance with various embodiments.

FIG. 2 is a schematic diagram illustrating a detailed structure of a transcoding system, in accordance with various embodiments.

Corresponding reference numerals indicate corresponding parts throughout the several views of the drawings.

### DETAILED DESCRIPTION

Example embodiments will now be described more fully with reference to the accompanying drawings.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

The basic idea of the various embodiments may be as follows. After receiving a transcoding request (carrying an identifier or contents of a file to be transcoded, a destination device type, and/or destination format information) from a client, when determining that a destination file corresponding to the transcoding request already exists in a server side, the server side may return destination file information to the client. When determining that the destination file corresponding to the transcoding request does not exist in the server side, after executing transcoding operations, the server side may return the destination file information obtained after transcoding to the client.

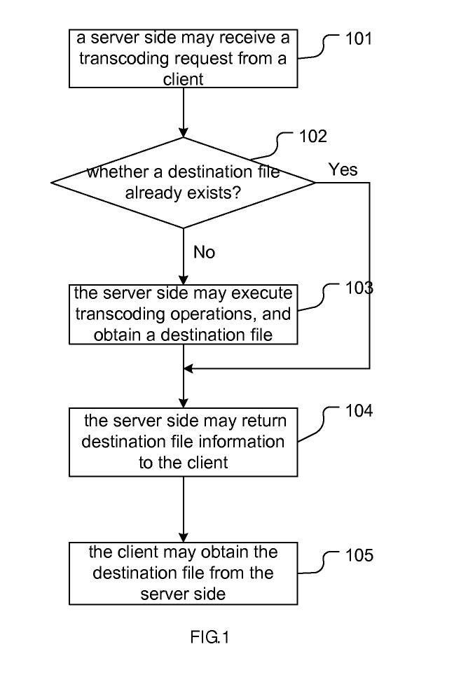

FIG. 1 is a flowchart illustrating a transcoding method, in accordance with various embodiments. As shown in FIG. 1, the method may include the following blocks.

In block 101, a server side may receive a transcoding request from a client.

In block 102, the server side may determine whether a destination file corresponding to the transcoding request already exists in the server side, when determining that the destination file corresponding to the transcoding request does not exist in the server side, proceed with block 103; when determining that the destination file corresponding to the transcoding request already exists in the server side, proceed with block 104.

In block 103, after executing transcoding operations and obtaining the destination file (that is, the transcoding is completed), the server side may proceed with block 104.

In block 104, the server side may return destination file information to the client.

In block 105, the client may obtain the destination file from the server side.

In block 101, specifically speaking, a transcoding task management server may receive the transcoding request from the client. The transcoding request generally carries an identifier or contents of a file to be transcoded, a destination device type, and/or, destination format information. The identifier of the file to be transcoded may be a Uniform Resource Locator (URL) address, which provides file downloading.

It should be noted that, the server side generally needs to maintain a corresponding relationship, which is about contents of a file being transcoded, contents of a transcoded file, and an outputting mode corresponding to the transcoding request. The file being transcoded generally takes hash of file contents as a unique identifier. The transcoded file generally takes the hash of file contents and the outputting mode corresponding to the transcoding request (such as parameter format, bit stream used for selecting transcoding, and so on) as a unique identifier. A corresponding relationship between a file being transcoded and a transcoded file is generally maintained by a transcoding task management server. Subsequently, the process of the server side determining whether the destination file corresponding to the transcoding request exists in block 102 may include the following. The server side may obtain the hash of file contents of the file to be transcoded and the outputting mode corresponding to the transcoding request, based on the identifier or contents of the file to be transcoded, as well as destination device type, and/or, destination format information. Subsequently, the server side may determine whether the destination file corresponding to the transcoding request exists in the server side, based on the corresponding relationship among the hash of file contents of the file being transcoded, the hash of file contents of the transcoded file, and the outputting mode corresponding to the transcoding request. In other words, based on parameters carried by the transcoding request and the corresponding relationship, it may be ascertained whether a certain format corresponding to a certain file has already been transcoded, and a file before transcoding which corresponds to a certain transcoded file.

The server side generally includes multiple transcoding servers. In block 103, when executing the transcoding operations by the server side, a transcoding scheduling server needs to schedule transcoding servers to transcode. Specifically speaking, a transcoding server may periodically report transcoding progress and intermediate state information to the transcoding task management server via the transcoding scheduling server, such that the client may obtain transcoding progress information. The transcoding scheduling server may schedule transcoding tasks, based on loads of transcoding server group. When the identifier of a file to be transcoded carried in the transcoding request is the URL address of the file to be transcoded, the transcoding task management server may forward the URL address to the transcoding scheduling server, such that the transcoding scheduling server may execute the scheduling. The scheduled transcoding server may download a file from the URL address, and transcode the file. When the transcoding request carries contents of the file to be transcoded, the transcoding task management server may inform the client to directly upload the contents of the file to be transcoded to the scheduled transcoding server, after obtaining scheduling information from the transcoding scheduling server.

It should be noted that, in block 103, when executing the transcoding operations by the server side, the server side may convert the file to be transcoded into a destination file specified in the transcoding request. The server side may also convert the file to be transcoded into a file of another format. Thus, when receiving a corresponding transcoding request, the server side may directly provide the destination file for the client.

In block 104, the destination file information may be carried by a transcoding success message. The destination file information may at least include address of the destination file, such that the client may obtain the destination file from the address based on the transcoding success message.

The destination file information may also be contents of the destination file pushed by the server side to the client.

It should be noted that, when the transcoding operations executed by the server side in block 103 have failed, a transcoding failure message may be transmitted to the client. The transcoding failure message may further carry failure reasons.

Correspondingly, the present disclosure also provides a transcoding system, which may include a server side and a client.

After receiving a transcoding request from the client, the server side determines whether a destination file corresponding to the transcoding request already exists in the server side. When determining that the destination file corresponding to the transcoding request already exists in the server side, the server side may return destination file information to the client. When determining that the destination file corresponding to the transcoding request does not exist in the server side, after executing transcoding operations, the server side may return the destination file information obtained after transcoding to the client.

The client transmits the transcoding request to the server side, and obtain the destination file from the server side, after receiving the destination file information from the server side.

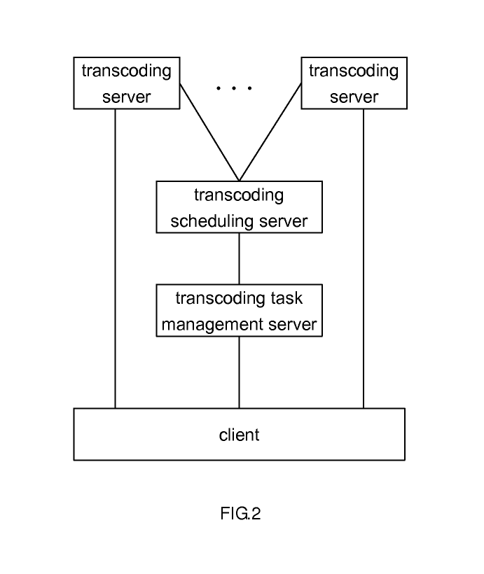

FIG. 2 is a schematic diagram illustrating a detailed structure of a transcoding system, in accordance with an example of the present disclosure. As shown in FIG. 2, specifically speaking, a server side may include a transcoding task management server, a transcoding scheduling server and at least one transcoding server.

The transcoding task management server receives a transcoding request from a client, and determines whether a destination file corresponding to the transcoding request already exists in the server side. When determining that the destination file corresponding to the transcoding request already exists in the server side, the transcoding task management server may transmit destination file information to the client. When determining that the destination file corresponding to the transcoding request does not exist in the server side, the transcoding task management server may inform the transcoding scheduling server to execute transcoding operations. After transcoding is successful, the destination file information may be transmitted by the transcoding task management server to the client.

The transcoding scheduling server schedules transcoding servers to transcode, based on loads of the transcoding servers, and informs the transcoding task management server after the transcoding is successful.

The transcoding server executes transcoding operations, based on scheduling of the transcoding scheduling server.

The transcoding request transmitted by the client may carry an identifier or contents of a file to be transcoded, as well as a destination device type, and/or, destination format information.

The destination file information returned by the server side may at least include an address, which may provide the destination file.

The transcoding task management server further maintains a corresponding relationship, which is about contents of a file being transcoded, contents of a transcoded file, and an outputting mode corresponding to the transcoding request.

The corresponding relationship maintained by the transcoding task management server, which is about contents of the file being transcoded, the contents of the transcoded file and the outputting mode corresponding to the transcoding request may refer to a corresponding relationship, which is about hash of contents of the file being transcoded, hash of contents of the transcoded file and the outputting mode corresponding to the transcoding request.

The process of the transcoding task management server determining whether the destination file corresponding to the transcoding request exists in the server side may include the following. The server side may obtain the hash of contents of the file to be transcoded and the outputting mode corresponding to the transcoding request, based on the identifier or contents of the file to be transcoded, as well as destination device type, and/or, destination format information, which are carried in the transcoding request. Subsequently, the server side may determine whether the destination file corresponding to the transcoding request exists in the server side, based on the corresponding relationship established by the server side, which is about the hash of contents of the file being transcoded, the hash of contents of the transcoded file and the outputting mode corresponding to the transcoding request.

When determining that the destination file corresponding to the transcoding request does not exist in the server side, and the identifier of the file to be transcoded carried in the transcoding request is the URL address of the file to be transcoded, the transcoding task management server forwards the URL address to the scheduled transcoding server via the transcoding scheduling server. When determining that the destination file corresponding to the transcoding request does not exist in the server side, and the transcoding request carries the contents of the file to be transcoded, the transcoding task management server informs the transcoding scheduling server to schedule transcoding servers, and then informs the client to directly upload the contents of the file to be transcoded to the scheduled transcoding server to be transcoded.

The transcoding server downloads a file and transcodes the file, based on the URL address received from the transcoding scheduling server, or, transcodes the contents of the file uploaded by the client.

Optionally, the transcoding task management server may generate a unique identification number for each independent transcoding task, and receive transcoding progress reported by the transcoding server via the transcoding scheduling server, such that the client may search out the transcoding progress. When the transcoding has failed, the client may obtain specific failure reasons from the server side.

After registering the address of the transcoding server to the transcoding scheduling server, the transcoding server may become the scheduled transcoding server. Subsequently, the transcoding server needs to periodically report information about the transcoding server, such as disk space, CPU load information. In addition, when executing the transcoding operations, based on the destination device, and/or, specified destination format selected by a user, the transcoding server needs to report execution progress about the transcoding operation to the transcoding scheduling server.

The transcoding scheduling server may accept the report about load information of a node in a transcoding server cluster, and dynamically schedule transcoding tasks to different transcoding server nodes to be executed, based on the loads of transcoding servers. In addition, the transcoding scheduling server may accept the report about transcoding progress submitted by the transcoding server, meanwhile report the progress information to the transcoding task management server.

In accordance with the method and system for executing format conversion at a server side put forward by the present disclosure, a client may generate a transcoding request, based on type of a user device (such as model of a mobile device, screen size and network bandwidth). The transcoding request may be compatible with various mobile video applications. After receiving the transcoding request by the server side, the transcoding may be automatically executed in the server side, or appropriate contents resources in the server side may be matched. When the matching is successful, a reminder may be automatically generated. The client may get back the destination file from the server side, or the client may directly play in the manner of streaming media. In the present disclosure, centralized transcoding mode may be converted into distributed cloud transcoding mode. Cluster technologies may be used to accelerate. Under the management of scheduler, multiple transcoding tasks may be executed in parallel within the cluster, such that transcoding throughput may be greatly improved. Regarding the client, transcoding cluster is transparent. The client does not need to understand technical details about transcoding cluster. The client only needs to submit transcoding tasks to the server. When the transcoding is finished, the client may extract a multimedia file from a specified location.

In accordance with technical solutions of the present disclosure, the transcoding may be distributed between the client and server side once again, such that calculating power, bandwidth power and storage power of the client and server side may reach a balance. Subsequently, the action of transcoding, which consumes a lot of CPU resources, may be completed by the powerful server, such that client resources may be saved. After being transcoded, the same video or audio file may be simultaneously used by different users within the validity of temporary storage. The same video or audio file does not need to be transcoded once again, which may be directly gotten back from the server by consuming some network bandwidth. During the procedure of processing one file or data flow, the transcoding server may synchronically convert the file into various destination files with different resolutions, different code rates or different formats. The specific target of conversion depends on destination device and client device parameters, in which the client device parameters are carried by the transcoding request, when the client initiates the transcoding. Thus, higher processing efficiency may be achieved, and generation of contents of various platforms may be completed quickly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A transcoding method, comprising:
receiving, by a server side, a transcoding request from a client;
determining, by the server side, whether a destination file corresponding to the transcoding request already exists in the server side;
when determining that the destination file corresponding to the transcoding request already exists in the server side, returning, by the server side, destination file information to the client; and
when determining that the destination file corresponding to the transcoding request does not exist in the server side, executing, by the server side, transcoding operations, and returning the destination file information obtained after executing the transcoding operations to the client.

2. The transcoding method according to claim 1, wherein the transcoding request carries an identifier or contents of a file to be transcoded, as well as a destination device type, and/or, destination format information.

3. The transcoding method according to claim 2, further comprising:
maintaining, by the server side, a corresponding relationship among contents of the file to be transcoded, contents of a transcoded file and an outputting mode corresponding to the transcoding request;
wherein determining by the server side whether the destination file corresponding to the transcoding request already exists in the server side comprises:
determining whether the destination file corresponding to the transcoding request already exists in the server side, based on parameters carried by the transcoding request, as well as the corresponding relationship maintained by the server side, which is among the contents of the file to be transcoded, the contents of the transcoded file and the outputting mode corresponding to the transcoding request.

4. The transcoding method according to claim 3, wherein the corresponding relationship maintained by the server side, which is among the contents of the file to be transcoded, the contents of the transcoded file and the outputting mode corresponding to the transcoding request comprises:
a corresponding relationship among a hash of the contents of the file to be transcoded, a hash of the contents of the transcoded file, and the outputting mode corresponding to the transcoding request;
wherein determining by the server side whether the destination file corresponding to the transcoding request already exists in the server side comprises:
obtaining, by the server side, the hash of the contents of the file to be transcoded, and the outputting mode corresponding to the transcoding request, based on the identifier or contents of the file to be transcoded carried in the transcoding request, as well as the destination device type, and/or, the destination format information; and
determining whether the destination file corresponding to the transcoding request already exists in the server side, based on the corresponding relationship maintained by the server side, which is among the hash of the contents of the file to be transcoded, the hash of the contents of the transcoded file and the outputting mode corresponding to the transcoding request.

5. The transcoding method according to claim 2, wherein the server side comprises at least one transcoding server, and the identifier of the file to be transcoded comprises a Uniform Resource Locator (URL) address of the file to be transcoded;
wherein executing by the server side the transcoding operations comprises:
scheduling a transcoding server to transcode, based on load of the at least one transcoding server;
when the identifier of the file to be transcoded carried by the transcoding request is the URL address of the file to be transcoded, downloading, by the transcoding server scheduled, a file from the URL address and transcoding the file;
when the transcoding request carries the contents of the file to be transcoded, informing, by the server side, the client to upload the contents of the file to be transcoded to the scheduled transcoding server to be transcoded.

6. The transcoding method according to claim 1, wherein executing by the server side the transcoding operations comprises:
transcoding, by the server side, the file to be transcoded to the destination file specified in the transcoding request, and transcoding the file to be transcoded to a file of another format except for the specified destination file.

7. The transcoding method according to claim 1, wherein the destination file information at least comprises an address which provides the destination file.

8. A transcoding system, comprising a server side and a client, wherein
the server side determines whether a destination file corresponding to a transcoding request already exists in the server side, after receiving the transcoding request from the client;
when determining that the destination file corresponding to the transcoding request already exists in the server side, the server side further returns destination file information to the client;
when determining that the destination file corresponding to the transcoding request does not exist in the server side, the server side further executes transcoding operations, and returns the destination file information obtained after executing the transcoding operations to the client; and
the client transmits the transcoding request to the server side, and obtains the destination file from the server side, after receiving the destination file information from the server side.

9. The transcoding system according to claim 8, wherein the server side comprises a transcoding task management server, a transcoding scheduling server and at least one transcoding server,
the transcoding task management server receives the transcoding request from the client, and determines whether the destination file corresponding to the transcoding request already exists in the server side;
when determining that the destination file corresponding to the transcoding request already exists in the server side, the transcoding task management server further transmits the destination file information to the client;
when determining that the destination file corresponding to the transcoding request does not exist in the server side, the transcoding task management server further informs the transcoding scheduling server to execute the transcoding operations, and transmits the destination file information to the client when the transcoding operations are successful;
the transcoding scheduling server schedules a transcoding server to transcode, based on load of the at least one transcoding server, and informs the transcoding task management server when transcoding is successful; and
the transcoding server executes the transcoding operations based on scheduling of the transcoding scheduling server.

10. The transcoding system according to claim 9, wherein the transcoding request transmitted by the client carries an identifier or contents of a file to be transcoded, as well as a destination device type, and/or, destination format information; and
the transcoding task management server maintains a corresponding relationship among contents of the file to be transcoded, contents of a transcoded file, and an outputting mode corresponding to the transcoding request, and determines whether the destination file corresponding to the transcoding request already exists in the server side, based on parameters carried by the transcoding request, as well as the corresponding relationship among the contents of the file to be transcoded, the contents of the transcoded file and the outputting mode corresponding to the transcoding request.

11. The transcoding system according to claim 10, wherein the corresponding relationship maintained by the transcoding task management server, which is among the contents of the file to be transcoded, the contents of the transcoded file, and the outputting mode corresponding to the transcoding request, comprises:
a corresponding relationship among a hash of the contents of the file to be transcoded, a hash of the contents of the transcoded file, and the outputting mode corresponding to the transcoding request; and
the transcoding task management server obtains the hash of the contents of the file to be transcoded and the outputting mode corresponding to the transcoding request, based on the identifier or contents of the file to be transcoded, as well as the destination device type, and/or, the destination format information carried in the transcoding request, and determines whether the destination file corresponding to the transcoding request already exists in the server side, based on the corresponding relationship maintained by the server side, which is among the hash of the contents of the file to be transcoded, the hash of the contents of the transcoded file, and the outputting mode corresponding to the transcoding request.

12. The transcoding system according to claim 10, wherein when determining that the destination file corresponding to the transcoding request does not exist in the server side, and the identifier of the file to be transcoded carried in the transcoding request is a Uniform Resource Locator (URL) address of the file to be transcoded, the transcoding task management server further forwards the URL address to the transcoding server scheduled via the transcoding scheduling server;
when determining that the destination file corresponding to the transcoding request does not exist in the server side, and the transcoding request carries the contents of the file to be transcoded, the transcoding task management server further informs the transcoding scheduling server to schedule a transcoding server, and informs the client to upload the contents of the file to be transcoded to the scheduled transcoding server to be transcoded; and
the transcoding server downloads a file from the URL address received from the transcoding scheduling server, and transcodes the file downloaded, or transcodes the contents of the file to be transcoded uploaded by the client.

13. The transcoding system according to claim 8, wherein the server side further transcodes the file to be transcoded to the destination file specified in the transcoding request, or transcodes the file to be transcoded to a file of another format except for the specified destination file.

14. The transcoding system according to claim 8, wherein the destination file information at least comprises an address, which provides the destination file.
